(19) United States
(12) Patent Application Publication
(10) Pub. No.: US 2024/0106742 A1
(43) Pub. Date: Mar. 28, 2024

(54) SPATIAL AWARENESS NAVIGATION TECHNIQUES ON UNMANNED AERIAL VEHICLES (SPATIAL AWARENESS)

(71) Applicant: Rockwell Collins, Inc., Cedar Rapids, IA (US)

(72) Inventors: Anthony D. Schaefer, Marion, IA (US); Tj T. Kwon, Marion, IA (US); James Kleveland, Marion, IA (US)

(21) Appl. No.: 17/990,491

(22) Filed: Nov. 18, 2022

Related U.S. Application Data
(63) Continuation-in-part of application No. 17/957,881, filed on Sep. 30, 2022.
Application No. 17/957,881 is a continuation-in-part of application No. 17/857,920, filed on Jul. 5, 2022.
Application No. 17/857,920 is a continuation-in-part of application No. PCT/US22/24653, filed on Apr. 13, 2022.
Application No. PCT/US22/24653 is a continuation of application No. 17/233,107, filed on Apr. 16, 2021, now Pat. No. 11,726,162.
Application No. 17/857,920 is a continuation of application No. 17/541,703, filed on Dec. 3, 2021.
Application No. 17/541,703 is a continuation-in-part of application No. 17/408,156, filed on Aug. 20, 2021, now Pat. No. 11,737,121.
Application No. 17/408,156 is a continuation-in-part of application No. 17/233,107, filed on Apr. 16, 2021, now Pat. No. 11,726,162.
Application No. 17/233,107 is a continuation-in-part of application No. 17/079,175, filed on Oct. 23, 2020, now Pat. No. 11,304,084.
Application No. 17/079,175 is a continuation-in-part of application No. 17/020,231, filed on Sep. 14, 2020, now Pat. No. 11,296,966.
Application No. 17/020,231 is a continuation-in-part of application No. 16/987,671, filed on Aug. 7, 2020, now Pat. No. 11,290,942.
Application No. 16/987,671 is a continuation-in-part of application No. 16/698,230, filed on Nov. 27, 2019, now Pat. No. 10,999,778.
Application No. 17/857,920 is a continuation of application No. 17/534,061, filed on Nov. 23, 2021, now Pat. No. 11,665,658.
Application No. 17/957,881 is a continuation-in-part of application No. 17/846,625, filed on Jun. 22, 2022.
Application No. 17/846,625 is a continuation-in-part of application No. 17/941,907, filed on Sep. 9, 2022.
Application No. 17/941,907 is a continuation-in-part of application No. 17/940,898, filed on Sep. 8, 2022.
Application No. 17/940,898 is a continuation-in-part of application No. 17/857,920, filed on Jul. 5, 2022.
(60) Provisional application No. 63/344,445, filed on May 20, 2022.

(51) Int. Cl. H04L 45/42; H04L 45/00; H04L 45/02; H04L 45/12

(52) U.S. Cl. CPC H04L 45/42; H04L 45/02; H04L 45/123; H04L 45/32

(57) ABSTRACT

A system may include a transmitter node and a receiver node. Each node may include a communications interface including at least one antenna element and a controller operatively coupled to the communications interface, the controller including one or more processors, wherein the controller has information of own node velocity and own node orientation. Each node may be time synchronized to apply Doppler corrections associated with said node's own motions relative to a common reference frame. The common reference frame may be known to the transmitter node and the receiver node prior to the transmitter node transmitting signals to the receiver node. The receiver node may be an autonomous vehicle. The receiver node may be configured to identify a risk of a potential collision with the transmitter node based on the signals.

### CROSS-REFERENCE TO RELATED APPLICATIONS

The present application is related to and claims priority from the following U.S. patent applications:
(a) U.S. patent application Ser. No. 17/233,107, filed Apr. 16, 2021, which is incorporated by reference in its entirety;
(b) P.C.T. Patent Application No. PCT/US22/24653, filed Apr. 13, 2022, which claims priority to U.S. patent application Ser. No. 17/233,107, filed Apr. 16, 2021, all of which are incorporated by reference in its entirety;
(c) U.S. patent application Ser. No. 17/408,156, filed Aug. 20, 2021, which claims priority to U.S. patent application Ser. No. 17/233,107, filed Apr. 16, 2021, all of which are incorporated by reference in its entirety;
(d) U.S. patent application Ser. No. 17/541,703, filed Dec. 3, 2021, which is incorporated by reference in its entirety, which claims priority to:
   1. U.S. patent application Ser. No. 17/408,156, filed Aug. 20, 2021, which is incorporated by reference in its entirety; and
   2. U.S. patent application Ser. No. 17/233,107, filed Apr. 16, 2021, all of which is incorporated by reference in its entirety;
(e) U.S. patent application Ser. No. 17/534,061, filed Nov. 23, 2021, which is incorporated by reference in its entirety;
(f) U.S. Patent Application No. 63/344,445, filed May 20, 2022, which is incorporated by reference in its entirety;
(g) U.S. patent application Ser. No. 17/857,920, filed Jul. 5, 2022, which is incorporated by reference in its entirety;
(h) U.S. Patent Application No. 63/400,138, filed Aug. 23, 2022, which is incorporated by reference in its entirety;
(i) U.S. patent application Ser. No. 17/940,898, filed Sep. 8, 2022, which is incorporated by reference in its entirety;
(j) U.S. patent application Ser. No. 17/941,907, filed Sep. 9, 2022, which is incorporated by reference in its entirety; and
(k) U.S. patent application Ser. No. 17/957,881, filed Sep. 30, 2022, which is incorporated by reference in its entirety.

### BACKGROUND

Mobile Ad-hoc NETworks (MANET; e.g., “mesh networks”) are known in the art as quickly deployable, self-configuring wireless networks with no pre-defined network topology. Each communications node within a MANET is presumed to be able to move freely. Additionally, each communications node within a MANET may be required to forward (relay) data packet traffic. Data packet routing and delivery within a MANET may depend on a number of factors including, but not limited to, the number of communications nodes within the network, communications node proximity and mobility, power requirements, network bandwidth, user traffic requirements, timing requirements, and the like.

MANETs face many challenges due to the limited network awareness inherent in such highly dynamic, low-infrastructure communication systems. Given the broad ranges in variable spaces, the challenges lie in making good decisions based on such limited information. For example, in static networks with fixed topologies, protocols can propagate information throughout the network to determine the network structure, but in dynamic topologies this information quickly becomes stale and must be periodically refreshed. It has been suggested that directional systems are the future of MANETs, but this future has not as yet been realized. In addition to topology factors, fast-moving platforms (e.g., communications nodes moving relative to each other) experience a frequency Doppler shift (e.g., offset) due to the relative radial velocity between each set of nodes. This Doppler frequency shift often limits receive sensitivity levels which can be achieved by a node within a mobile network.

When unmanned aerial vehicles (UAVs) are navigating in GPS contested environments, they may lose their current position location. This is a concern in general because it may reduce the chance of success of a mission. For example, a loss of position may result in losing track of a route or an objective. However, losing track of position may also cause other, more immediate issues. For example, aircraft may rely on position to help maintain a particular flying formation. For instance, when UAVs are operating in manned-unmanned team (MUM-T) mode, as they continue to move in 3-dimensional (3D) space, without position information to maintain their flying formation they could eventually collide with other UAVs or potentially worse, a manned aircraft.

Therefore, it would be advantageous to provide a system that cures the shortcomings described above, such as by providing up-to-date spatial information.

### SUMMARY

A system may include a transmitter node and a receiver node. Each node may include a communications interface including at least one antenna element and a controller operatively coupled to the communications interface, the controller including one or more processors, wherein the controller has information of own node velocity and own node orientation. Each node of the transmitter node and the receiver node may be in motion relative to each other. Each node may be time synchronized to apply Doppler corrections associated with said node's own motions relative to a common reference frame. The common reference frame may be known to the transmitter node and the receiver node prior to the transmitter node transmitting signals to the receiver node and prior to the receiver node receiving the signals from the transmitter node. The receiver node may be an autonomous vehicle. The receiver node may be configured to identify a risk of a potential collision with the transmitter node based on the signals.

In a further aspect, a method may include: providing a transmitter node and a receiver node, wherein each node of the transmitter node and the receiver node are time synchronized, wherein each node of the transmitter node and the receiver node are in motion relative to each other, wherein each node of the transmitter node and the receiver node comprises a communications interface including at least one antenna element, wherein each node of the transmitter node and the receiver node further comprises a controller operatively coupled to the communications interface, the controller including one or more processors, wherein the controller has information of own node velocity and own node orientation; based at least on the time synchronization, applying, by the transmitter node, Doppler corrections to the transmitter node's own motions relative to a common reference frame; and based at least on the time synchronization, applying, by the receiver node, Doppler corrections to the receiver node's own motions relative to the common reference frame, wherein the common reference frame is known to the transmitter node and the receiver node prior to the transmitter node transmitting signals to the receiver node and prior to the receiver node receiving the signals from the transmitter node. The receiver node may be an autonomous vehicle. The receiver node may be configured to identify a risk of a potential collision with the transmitter node based on the signals.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 is a diagrammatic illustration of a mobile ad hoc network (MANET) and individual nodes thereof according to example embodiments of this disclosure.

FIG. 2A is a graphical representation of frequency shift profiles within the MANET of FIG. 1 according to example embodiments of this disclosure.

FIG. 2B is a graphical representation of frequency shift profiles within the MANET of FIG. 1 according to example embodiments of this disclosure.

FIG. 3 is a diagrammatic illustration of a transmitter node and a receiver node according to example embodiments of this disclosure.

FIG. 4A is a graphical representation of frequency shift profiles within the MANET of FIG. 3 according to example embodiments of this disclosure.

FIG. 4B is a graphical representation of frequency shift profiles within the MANET of FIG. 3 according to example embodiments of this disclosure.

FIG. 5 is an exemplary graph of sets for covering space according to example embodiments of this disclosure.

FIG. 6 is a diagrammatic illustration of a transmitter node and a receiver node according to example embodiments of this disclosure.

FIG. 7 is a flow diagram illustrating a method according to example embodiments of this disclosure.

FIG. 8A is a diagrammatic illustration of an AV and node with collision avoidance using location information.

FIG. 8B is a diagrammatic illustration of an AV and node with collision avoidance using spatial awareness according to example embodiments of this disclosure.

FIG. 9 is a flow diagram of a method for executing flight plans after loss of GPS signal according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment”, “in embodiments” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Broadly speaking, embodiments of the inventive concepts disclosed herein are directed to a method and a system for achieving situational awareness of vehicles (e.g., autonomous vehicles (AVs) such as unmanned autonomous vehicles (UAVs)). In embodiments, such situational awareness may be between vehicles such as a transmitter node and a receiver node, which may be time synchronized to apply Doppler corrections to a received and/or transmitted signal, the Doppler corrections being associated with said node's own motions relative to a common reference frame. For example, a vehicle may receive such a Doppler corrected signal and, based off the signal, determine that a potential collision may occur or that a risk is too high. Next, the vehicle, based on such a determination, may change a flight parameter (e.g., change course such as ascend, descend, turn left, turn right, and the like). In this regard, a collision may be avoided.

In embodiments, Doppler correction methodologies may include any methodology of applications incorporated by reference above. For example, embodiments may utilize spatial awareness (e.g., doppler nulling) methods including transmitter and receiver nodes being time synchronized to apply Doppler corrections. For instance, examples of doppler nulling methods include, but are not limited to, methods and any other descriptions disclosed in U.S. patent application Ser. No. 17/233,107, filed Apr. 16, 2021, which is hereby incorporated by reference in its entirety; and U.S. patent application Ser. No. 17/857,920, filed Jul. 5, 2022, which is hereby incorporated by reference in its entirety. Further examples are included in U.S. patent application Ser. No. 17/541,703, filed Dec. 3, 2021, which is hereby incorporated by reference in its entirety. In embodiments, doppler nulling methods allow for benefits such as, but not limited to, relatively quickly and/or efficiently detecting transmitter nodes and determining transmitter node attributes (e.g., transmitter node speed, transmitter node bearing, relative bearing of transmitter node relative to receiver node, relative distance of transmitter node relative to receiver node, and the like).

Some other communication protocols (e.g., typical communication methods) may require a higher signal to noise ratio (SNR) than doppler nulling methods. For example, doppler nulling methods may allow for using relatively less power (e.g., watts) and a weaker signal, while still providing for situational awareness, than other methods. Some other communication protocols, in order to provide for situational awareness, may require two-way communications of both the transmitter node and the receiver node in order to establish a communication link and to send attributes (e.g., location information data) of a transmitting node, thereby breaking radio silence of the receiving node.

Some other methods that lose location information (e.g., jamming or interference causing loss of GPS location information) may result in a collision without an adequate backup for quickly re-establishing a way to determine location information of oneself and other nodes.

At least some of these challenges are addressed by embodiments of the present disclosure.

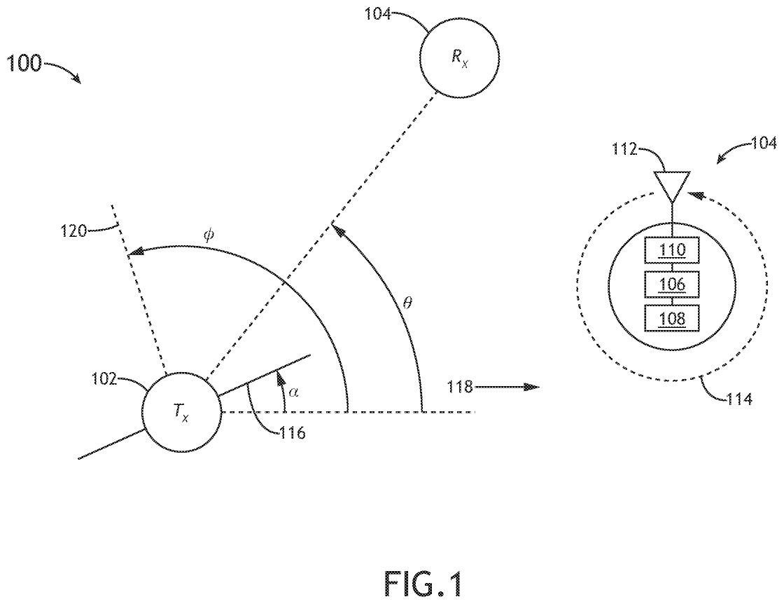

It is noted that U.S. patent application Ser. No. 17/857,920, filed Jul. 5, 2022, is at least partially reproduced by at least some of the illustrations of FIGS. 1-7 and at least some of the accompanying language below, in accordance with one or more embodiments of the present disclosure. In this regard, at least some examples of doppler nulling methods and systems may be better understood, in a nonlimiting manner, by reference to FIGS. 1-7. However, such embodiments and examples are provided merely for illustrative purposes and are not to be construed as limiting. For instance, in embodiments the transmitter node may be stationary rather than moving.

Moreover, and stated for purposes of navigating the disclosure only and not to be construed as limiting, descriptions that may more directly relate to avoiding collisions are further discussed after FIGS. 1-7.

Referring now to FIGS. 1-7, in some embodiments, a stationary receiver may determine a cooperative transmitter's direction and velocity vector by using a Doppler null scanning approach in two dimensions. A benefit of the approach is the spatial awareness without exchanging explicit positional information. Other benefits include discovery, synchronization, and Doppler corrections which are important for communications. Some embodiment may combine coordinated transmitter frequency shifts along with the transmitter's motion induced Doppler frequency shift to produce unique net frequency shift signal characteristics resolvable using a stationary receiver to achieve spatial awareness. Further, some embodiment may include a three-dimensional (3D) approach with the receiver and the transmitter in motion.

Some embodiments may use analysis performed in a common reference frame (e.g., a common inertial reference frame, such as the Earth, which may ignore the curvature of Earth), and it is assumed that the communications system for each of the transmitter and receiver is informed by the platform of its own velocity and orientation. The approach described herein can be used for discovery and tracking, but the discussion here focuses on discovery which is often the most challenging aspect.

The meaning of the ‘Doppler Null’ can be explained in part through a review of the two-dimensional (2D) case without the receiver motion, and then may be expounded on by a review of adding the receiver motion to the 2D case, and then including receiver motion in the 3D case.

The Doppler frequency shift of a communications signal is proportional to the radial velocity between transmitter and receiver, and any significant Doppler shift is typically a hindrance that should be considered by system designers. In contrast, some embodiments utilize the Doppler effect to discriminate between directions with the resolution dictated by selected design parameters. Furthermore, such embodiments use the profile of the net frequency shift as the predetermined ‘Null’ direction scans through the angle space. The resultant profile is sinusoidal with an amplitude that provides the transmitter's speed, a zero net frequency shift when the ‘Null’ direction aligns with the receiver, and a minimum indicating the direction of the transmitter's velocity. It should be noted that that the transmitter cannot correct for Doppler in all directions at one time so signal characteristics are different in each direction and are different for different transmitter velocities as well. It is exactly these characteristics that the receiver uses to determine spatial awareness. The received signal has temporal spatial characteristics that can be mapped to the transmitter's direction and velocity. This approach utilizes the concept of a ‘Null’ which is simply the direction where the transmitter perfectly corrects for its own Doppler shift. The same ‘Nulling’ protocol runs on each node and scans through all directions. Here we arbitrarily illustrate the scanning with discrete successive steps of 10 degrees but in a real system; however, it should be understood that any suitable step size of degrees may be used for Doppler null scanning.

As already mentioned, one of the contributions of some embodiments is passive spatial awareness. Traditionally, spatial information for neighbor nodes (based on a global positioning system (GPS) and/or gyros and accelerometers) can be learned via data communication. Unfortunately, spatial awareness via data communication, referred to as active spatial awareness is possible only after communication has already been established, not while discovering those neighbor nodes. Data communication is only possible after the signals for neighbor nodes have been discovered, synchronized and Doppler corrected. In contrast, in some embodiments, the passive spatial awareness described herein may be performed using only synchronization bits associated with acquisition. This process can be viewed as physical layer overhead and typically requires much lower bandwidth compared to explicit data transfers. The physical layer overheads for discovery, synchronization and Doppler correction have never been utilized for topology learning for upper layers previously.

Traditionally, network topology is harvested via a series of data packet exchanges (e.g., hello messaging and link status advertisements). The passive spatial awareness may eliminate hello messaging completely and provide a wider local topology which is beyond the coverage of hello messaging. By utilizing passive spatial awareness, highly efficient mobile ad hoc networking (MANET) is possible. Embodiments may improve the functioning of a network, itself.

Referring to FIG. 1, a multi-node communications network 100 is disclosed. The multi-node communications network 100 may include multiple communications nodes, e.g., a transmitter (Tx) node 102 and a receiver (Rx) node 104.

In embodiments, the multi-node communications network 100 may include any multi-node communications network known in the art. For example, the multi-node communications network 100 may include a mobile ad-hoc network (MANET) in which the Tx and Rx nodes 102, 104 (as well as every other communications node within the multi-node communications network) is able to move freely and independently. Similarly, the Tx and Rx nodes 102, 104 may include any communications node known in the art which may be communicatively coupled. In this regard, the Tx and Rx nodes 102, 104 may include any communications node known in the art for transmitting/transceiving data packets. For example, the Tx and Rx nodes 102, 104 may include, but are not limited to, radios (such as on a vehicle or on a person), mobile phones, smart phones, tablets, smart watches, laptops, and the like. In embodiments, the Rx node 104 of the multi-node communications network 100 may each include, but are not limited to, a respective controller 106 (e.g., control processor), memory 108, communication interface 110, and antenna elements 112. (In embodiments, all attributes, capabilities, etc. of the Rx node 104 described below may similarly apply to the Tx node 102, and to any other communication node of the multi-node communication network 100.)

In embodiments, the controller 106 provides processing functionality for at least the Rx node 104 and can include any number of processors, micro-controllers, circuitry, field programmable gate array (FPGA) or other processing systems, and resident or external memory for storing data, executable code, and other information accessed or generated by the Rx node 104. The controller 106 can execute one or more software programs embodied in a non-transitory computer readable medium (e.g., memory 108) that implement techniques described herein. The controller 106 is not limited by the materials from which it is formed or the processing mechanisms employed therein and, as such, can be implemented via semiconductor(s) and/or transistors (e.g., using electronic integrated circuit (IC) components), and so forth.

In embodiments, the memory 108 can be an example of tangible, computer-readable storage medium that provides storage functionality to store various data and/or program code associated with operation of the Rx node 104 and/or controller 106, such as software programs and/or code segments, or other data to instruct the controller 106, and possibly other components of the Rx node 104, to perform the functionality described herein. Thus, the memory 108 can store data, such as a program of instructions for operating the Rx node 104, including its components (e.g., controller 106, communication interface 110, antenna elements 112, etc.), and so forth. It should be noted that while a single memory 108 is described, a wide variety of types and combinations of memory (e.g., tangible, non-transitory memory) can be employed. The memory 108 can be integral with the controller 106, can comprise stand-alone memory, or can be a combination of both. Some examples of the memory 108 can include removable and non-removable memory components, such as random-access memory (RAM), read-only memory (ROM), flash memory (e.g., a secure digital (SD) memory card, a mini-SD memory card, and/or a micro-SD memory card), solid-state drive (SSD) memory, magnetic memory, optical memory, universal serial bus (USB) memory devices, hard disk memory, external memory, and so forth.

In embodiments, the communication interface 110 can be operatively configured to communicate with components of the Rx node 104. For example, the communication interface 110 can be configured to retrieve data from the controller 106 or other devices (e.g., the Tx node 102 and/or other nodes), transmit data for storage in the memory 108, retrieve data from storage in the memory, and so forth. The communication interface 110 can also be communicatively coupled with the controller 106 to facilitate data transfer between components of the Rx node 104 and the controller 106. It should be noted that while the communication interface 110 is described as a component of the Rx node 104, one or more components of the communication interface 110 can be implemented as external components communicatively coupled to the Rx node 104 via a wired and/or wireless connection. The Rx node 104 can also include and/or connect to one or more input/output (I/O) devices. In embodiments, the communication interface 110 includes or is coupled to a transmitter, receiver, transceiver, physical connection interface, or any combination thereof.

It is contemplated herein that the communication interface 110 of the Rx node 104 may be configured to communicatively couple to additional communication interfaces 110 of additional communications nodes (e.g., the Tx node 102) of the multi-node communications network 100 using any wireless communication techniques known in the art including, but not limited to, GSM, GPRS, CDMA, EV-DO, EDGE, WiMAX, 3G, 4G, 4G LTE, 5G, WiFi protocols, RF, LoRa, and the like.

In embodiments, the antenna elements 112 may include directional or omnidirectional antenna elements capable of being steered or otherwise directed (e.g., via the communications interface 110) for spatial scanning in a full 360-degree arc (114) relative to the Rx node 104.

In embodiments, the Tx node 102 and Rx node 104 may both be moving in an arbitrary direction at an arbitrary speed, and may similarly be moving relative to each other. For example, the Tx node 102 may be moving relative to the Rx node 104 according to a velocity vector 116, at a relative velocity V_{Tx} and a relative angular direction (an angle α relative to an arbitrary direction 118 (e.g., due east); θ may be the angular direction of the Rx node relative to due east.

In embodiments, the Tx node 102 may implement a Doppler nulling protocol. For example, the Tx node 102 may adjust its transmit frequency to counter the Doppler frequency offset such that there is no net frequency offset (e.g., “Doppler null”) in a Doppler nulling direction 120 (e.g., at an angle ϕ relative to the arbitrary direction 118). The transmitting waveform (e.g., the communications interface 110 of the Tx node 102) may be informed by the platform (e.g., the controller 106) of its velocity vector and orientation (e.g., α, V_{T}) and may adjust its transmitting frequency to remove the Doppler frequency shift at each Doppler nulling direction 120 and angle ϕ.

To illustrate aspects of some embodiments, we show the 2D dependence of the net frequency shift for a stationary receiver as a function of Null direction across the horizon, as shown in a top-down view of FIG. 1, where the receiver node 104 is stationary and positioned θ from east relative to the transmitter, the transmitter node 102 is moving with a speed |\vec{V_{T}}| and direction a from east and a snapshot of the scanning ϕ which is the ‘Null’ direction, exemplarily shown as 100 degrees in this picture.

The Doppler shift is a physical phenomenon due to motion and can be considered as a channel effect. In this example the transmitter node 102 is the only moving object, so it is the only source of Doppler shift. The Doppler frequency shift as seen by the receiver node 104 due to the transmitter node 102 motion is:

$$\frac{Δ {f}_{DOPPLER}}{f} = \frac{\vert \vec{{V}_{T}} \vert}{c} cos ( θ - α ) ,$$

where c is the speed of light

The other factor is the transmitter frequency adjustment term that should exactly compensate the Doppler shift when the ‘Null’ direction aligns with the receiver direction. It is the job of the transmitter node 102 to adjust its transmit frequency according to its own speed (|\vec{V_{T}}|), and velocity direction (α). That transmitter frequency adjustment (Δƒ_{T}) is proportional to the velocity projection onto the ‘Null’ direction (ϕ) and is:

$$\frac{Δ {f}_{T}}{f} = - \frac{\vert \vec{{V}_{T}} \vert}{c} cos ( φ - α )$$

The net frequency shift seen by the receiver is the sum of the two terms:

$$\frac{Δ {f}_{net}}{f} = \frac{\vert \vec{{V}_{T}} \vert}{c} [ cos ( θ - α ) - cos ( φ - α ) ]$$

It is assumed that the velocity vector and the direction changes slowly compared to the periodic measurement of Δƒₙₑₜ. Under those conditions, the unknown parameters (from the perspective of the receiver node 104) of α, |\vec{V_{T}}|, and θ are constants.

Furthermore, it is assumed that the receiver node 104 has an implementation that resolves the frequency of the incoming signal, as would be understood to one of ordinary skill in the art.

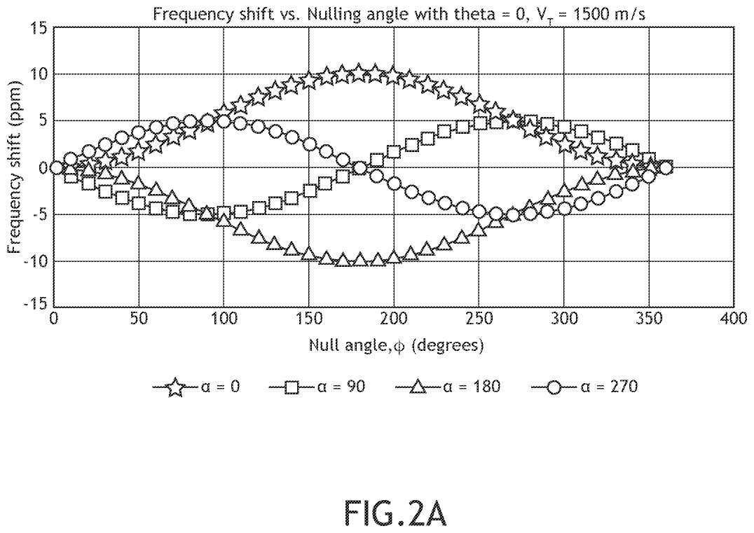

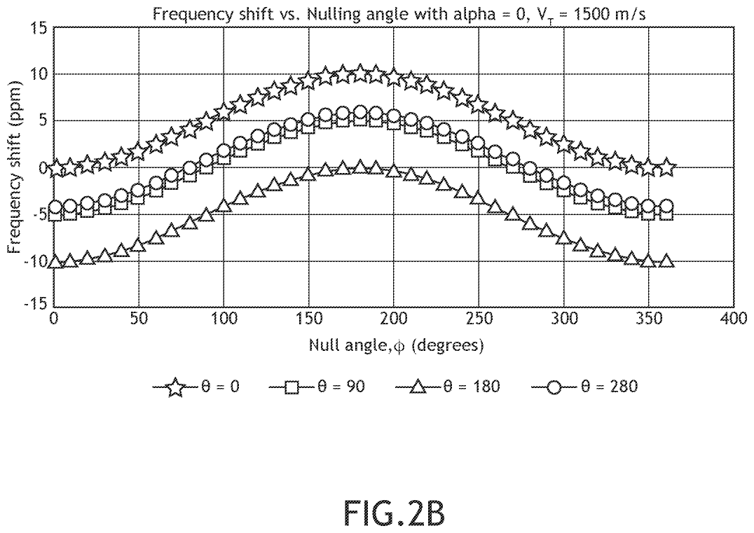

FIG. 2A shows the resulting net frequency shift as a function of the ‘Null’ direction for scenarios where a stationary receiver is East of the transmitter (theta=0), and with a transmitter speed of 1500 meters per second (m/s). FIG. 2B shows the results for a stationary receiver and for several directions with an Eastern transmitter node velocity direction (alpha=0). The frequency shifts are in units of parts per million (ppm). As shown in FIGS. 2A and 2B, the amplitude is consistent with the transmitter node's 102 speed of 5 ppm [|\vec{V_{T}}|/c*(1×10⁶)] regardless of the velocity direction or position, the net frequency shift is zero when the ‘Null’ angle is in the receiver direction (when ϕ=θ), and the minimum occurs when the ‘Null’ is aligned with the transmitter node's 102 velocity direction (when ϕ=α).

From the profile, the receiver node 104 can therefore determine the transmitter node's 102 speed, the transmitter node's 102 heading, and the direction of the transmitter node 102 is known to at most, one of two locations (since some profiles have two zero crossings). It should be noted that the two curves cross the y axis twice (0 & 180 degrees in FIG. 2A, and ±90 degrees in FIG. 2B) so there is initially an instance of ambiguity in position direction. In this case the receiver node 104 knows the transmitter node 102 is either East or West of the receiver node 104.

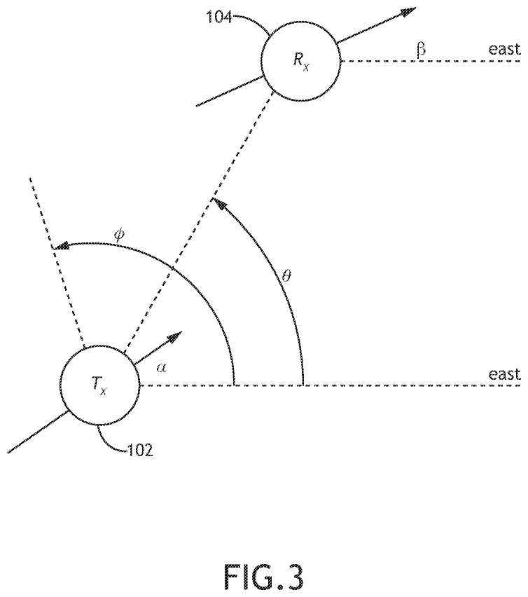

Referring to FIG. 3, a multi-node communications network 100 is disclosed. The multi-node communications network 100 may include multiple communications nodes, e.g., a transmitter (Tx) node 102 and a receiver (Rx) node 104. As shown in FIG. 3 both of the transmitter node 102 and the receiver node 104 are in motion in two dimensions.

The simultaneous movement scenario is depicted in FIG. 3 where the receiver node 104 is also moving in a generic velocity characterized by a speed |\vec{V_{R}}| and the direction, β. The protocol for the moving receiver node 104 incorporates a frequency adjustment on the receiver node's 104 side to compensate for the receiver node's 104 motion as well. The equations have two additional terms. One is a Doppler term for the motion of the receiver and the second is frequency compensation by the receiver.

Again, the Doppler shift is a physical phenomenon due to motion and can be considered as a channel effect, but in this case both the transmitter node 102 and the receiver node 104 are moving so there are two Doppler shift terms. The true Doppler shift as seen by the receiver due to the relative radial velocity is:

$$\frac{Δ {f}_{DOPPLER}}{f} = \frac{\vert \vec{{V}_{T}} \vert}{c} cos ( θ - α ) - \frac{\vert \vec{{V}_{R}} \vert}{c} cos ( θ - β )$$

The other factors are the transmitter node 102 and receiver node 104 frequency adjustment terms that exactly compensates the Doppler shift when the ‘Null’ direction aligns with the receiver direction. It is the job of the transmitter node 102 to adjust the transmitter node's 102 transmit frequency according to its own speed (|\vec{V_{T}}|), and velocity direction (α). That transmitter node frequency adjustment is proportional to the velocity projection onto the ‘Null’ direction (ϕ) and is the first term in the equation below.

It is the job of the receiver node 104 to adjust the receiver node frequency according to the receiver node's 104 own speed (|\vec{V_{R}}|), and velocity direction (β). That receiver node frequency adjustment is proportional to the velocity projection onto the ‘Null’ direction (ϕ) and is the second term in the equation below. The receiver node frequency adjustment can be done to the receive signal prior to the frequency resolving algorithm or could be done within the algorithm.

$$\frac{Δ {f}_{T \& R}}{f} = - \frac{\vert \vec{{V}_{T}} \vert}{c} cos ( φ - α ) + \frac{\vert \vec{{V}_{R}} \vert}{c} cos ( φ - β )$$

The net frequency shift seen by the receiver is the sum of all terms:

$$\frac{Δ {f}_{net}}{f} = \frac{\vert \vec{{V}_{T}} \vert}{c} [ cos ( θ - α ) - cos ( φ - α ) ] - \frac{\vert \vec{{V}_{R}} \vert}{c} [ cos ( θ - β ) - cos ( φ - β ) ]$$

Again, it is assumed that the receiver node 104 has an implementation that resolves the frequency of the incoming signal, as would be understood in the art.

Also, it is assumed that the velocity vector and direction changes slowly compared to the periodic measurement of Δƒₙₑₜ. Again, under such conditions, the unknown parameters (from the perspective of the receiver node 104) α, |\vec{V_{T}}|, and θ are constants.

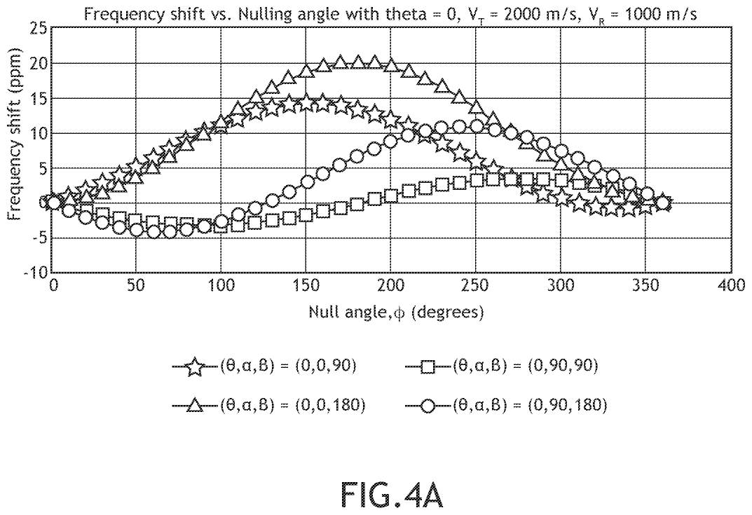

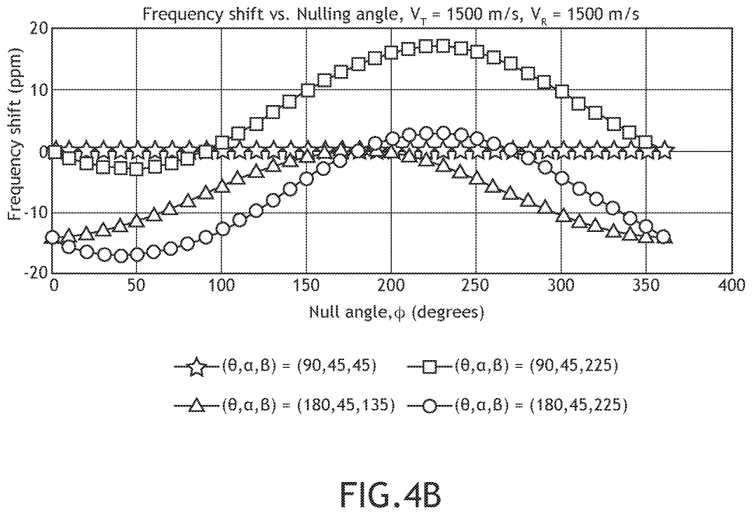

The net frequency shift for the two-dimensional (2D) moving receiver node 104 approach is shown in FIGS. 4A and 4B for several scenario cases of receiver node location, θ, and transmitter node and receiver node speeds (|\vec{V_{T}}| & |\vec{V_{R}}|), as well as transmitter node and receiver node velocity direction (α and β). FIG. 4A has different speeds for the transmitter node 102 and receiver node 104 as well as the receiver node location of θ=0. FIG. 4B has the same speed for the transmitter node and receiver node. Similarly, there are three concepts to notice here:
The amplitude is consistent with the relative velocity between transmitter node 102 and receiver node 104 [|(|\vec{V_{T}}|cos(α)−|\vec{V_{R}}|cos(β))|/c*(1e6)].
The net frequency shift is zero when the ‘Null’ angle is in the receiver direction (when ϕ=θ).
The minimum occurs when the ‘Null’ is aligned with the relative velocity direction (when ϕ=angle(|\vec{V_{T}}|cos(α)−|\vec{V_{R}}|cos(β))).

Again, there is an initial dual point ambiguity with the position, θ, but the transmitter node's 102 speed and velocity vector is known.

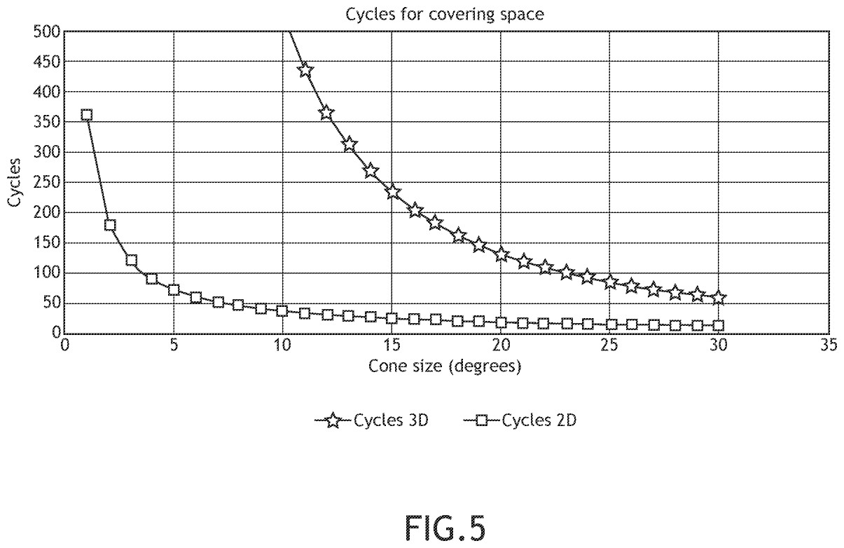

Referring now to FIG. 5, while the 2D picture is easier to visualize, the same principles apply to the 3D case. FIG. 5 shows a number of direction sets needed to span 3D and 2D space with different cone sizes (cone sizes are full width). Before diving into the equations, it's worth commenting on the size of the space when including another dimension. For example, when a ‘Null’ step size of 10 degrees was used in the previous examples, it took 36 sets to span the 360 degrees in 2D. Thus, if an exemplary detection angle of 10 degrees is used (e.g., a directional antenna with 10-degree cone) it would take 36 sets to cover the 2D space. The 3D fractional coverage can be computed by calculating the coverage of a cone compared to the full 4 pi steradians. The fraction is equal to the integral

$$FractionCoverage 3 D = \frac{{\int }_{0}^{ConeSize / 2} {r}^{2} sin ( θ′ ) d θ′ d φ}{4 π {r}^{2}} = \frac{1 - cos ( ConeSize / 2 )}{2}$$

$$FractionCoverage 2 D = 2 π / ConeSize$$

The number of sets to span the space is shown in FIG. 5 for both the 2D and 3D cases which correlates with discovery time. Except for narrow cone sizes, the number of sets is not drastically greater for the 3D case (e.g., approximately 15 times at 10 degrees, 7.3 time at 20 degrees, and around 4.9 times at 30 degrees). Unless systems are limited to very narrow cone sizes, the discovery time for 3D searches is not overwhelming compared to a 2D search.

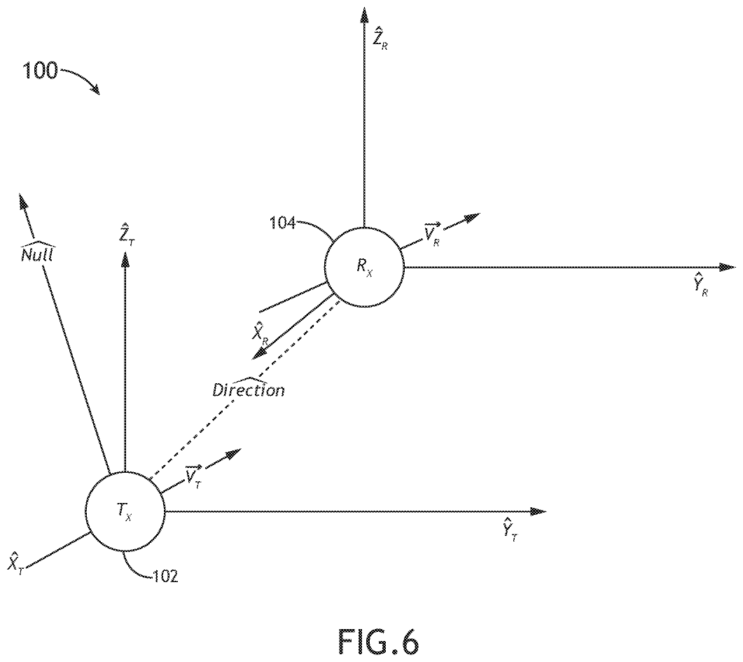

Referring now to FIG. 6, a multi-node communications network 100 is disclosed. The multi-node communications network 100 may include multiple communications nodes, e.g., a transmitter (Tx) node 102 and a receiver (Rx) node 104. As shown in FIG. 6 both of the transmitter node 102 and the receiver node 104 are in motion in three dimensions.

The 3D approach to Doppler nulling follows the 2D approach but it is illustrated here with angles and computed vectorially for simplicity.

In three dimensions, it is convenient to express the equations in vector form which is valid for 2 or 3 dimensions. FIG. 6 shows the geometry in 3 dimensions where Di [symbol] on is the unit vector pointing to the receiver from the transmitter, and [symbol] is the unit vector pointing in the ‘Null’ direction defined by the protocol.

The true Doppler shift as seen by the receiver node 104 due to the relative radial velocity which is the projection onto the Di [symbol] on vector:

$$\frac{Δ {f}_{DOPPLER}}{f} = \frac{1}{c} \vec{{V}_{T}} \cdot - \frac{1}{c} \vec{{V}_{R}} \cdot$$

The nulling protocol adjusts the transmit node frequency and receiver node frequency due to their velocity projections onto the [symbol] direction

$$\frac{Δ {f}_{T}}{f} = - \frac{1}{c} \vec{{V}_{T}} \cdot + \frac{1}{c} \vec{{V}_{R}} \cdot$$

The net frequency shift seen by the receiver node 104 is the sum of all terms:

$$\frac{Δ {f}_{net}}{f} = \frac{1}{c} \vec{{V}_{T}} \cdot - \frac{1}{c} \vec{{V}_{R}} \cdot - \frac{1}{c} \vec{{V}_{T}} \cdot + \frac{1}{c} \vec{{V}_{R}} \cdot$$

The net frequency shift for the 3D moving receiver node 104 approach is not easy to show pictorially but can be inspected with mathematical equations to arrive at useful conclusions. The first two terms are the Doppler correction (DC) offset and the last two terms are the null dependent terms. Since the [symbol] is the independent variable, the maximum occurs when (\vec{V_{R}}−\vec{V_{T}}) and [symbol] are parallel and is a minimum when they are antiparallel. Furthermore, the relative speed is determined by the amplitude,

$$Amplitude = \frac{1}{c} \vert \vec{{V}_{R}} - \vec{{V}_{T}} \vert$$

Lastly, the net frequency is zero when the [symbol] is parallel (i.e., parallel in same direction, as opposed to anti-parallel) to Di [symbol] on.

$$\frac{Δ {f}_{net}}{f} = 0 when , \text{} \frac{1}{c} \vec{{V}_{T}} \cdot - \frac{1}{c} \vec{{V}_{R}} \cdot = \frac{1}{c} \vec{{V}_{T}} \cdot - \frac{1}{c} \vec{{V}_{R}} \cdot or , ( \vec{{V}_{T}} - \vec{{V}_{R}} ) \cdot = ( \vec{{V}_{T}} - \vec{{V}_{R}} ) \cdot$$

For the 3D case:
The amplitude is consistent with the relative velocity between transmitter node 102 and receiver node 104 [|\vec{V_{R}}−\vec{V_{T}}|/c].
The net frequency shift is zero when the ‘Null’ angle is in the receiver node direction, (\vec{V_{T}}−\vec{V_{R}})·Di [symbol] on=(\vec{V_{T}}−\vec{V_{R}})· [symbol] ).
The minimum occurs when the ‘Null’ is aligned with the relative velocity direction.

Referring still to FIG. 6, in some embodiments, the system (e.g., the multi-node communications network 100) may include a transmitter node 102 and a receiver node 104. Each node of the transmitter node 102 and the receiver node 104 may include a communications interface 110 including at least one antenna element 112 and a controller operatively coupled to the communications interface, the controller 106 including one or more processors, wherein the controller 106 has information of own node velocity and own node orientation. The transmitter node 102 and the receiver node 104 may be in motion (e.g., in two dimensions or in three dimensions). The transmitter node 102 and the receiver node 104 may be time synchronized to apply Doppler corrections associated with said node's own motions relative to a common reference frame (e.g., a common inertial reference frame (e.g., a common inertial reference frame in motion or a stationary common inertial reference frame)). The common reference frame may be known to the transmitter node 102 and the receiver node 104 prior to the transmitter node 102 transmitting signals to the receiver node 104 and prior to the receiver node 104 receiving the signals from the transmitter node 102. In some embodiments, the system is a mobile ad-hoc network (MANET) comprising the transmitter node 102 and the receiver node 104.

In some embodiments, the transmitter node 102 and the receiver node 104 are time synchronized via synchronization bits associated with acquisition. For example, the synchronization bits may operate as physical layer overhead.

In some embodiments, the transmitter node 102 is configured to adjust a transmit frequency according to an own speed and an own velocity direction of the transmitter node 102 so as to perform a transmitter-side Doppler correction. In some embodiments, the receiver node 104 is configured to adjust a receiver frequency of the receiver node 104 according to an own speed and an own velocity direction of the receiver node 104 so as to perform a receiver-side Doppler correction. In some embodiments, an amount of adjustment of the adjusted transmit frequency is proportional to a transmitter node 102 velocity projection onto a Doppler null direction, wherein an amount of adjustment of the adjusted receiver frequency is proportional to a receiver node 104 velocity projection onto the Doppler null direction. In some embodiments, the receiver node 102 is configured to determine a relative speed between the transmitter node 102 and the receiver node 104. In some embodiments, the receiver node 104 is configured to determine a direction that the transmitter node 102 is in motion and a velocity vector of the transmitter node 102. In some embodiments, a maximum net frequency shift for a Doppler correction by the receiver node 104 occurs when a resultant vector is parallel to the Doppler null direction, wherein the resultant vector is equal to a velocity vector of the receiver node 104 minus the velocity vector of the transmitter node 102. In some embodiments, a minimum net frequency shift for a Doppler correction by the receiver node 104 occurs when a resultant vector is antiparallel to the Doppler null direction, wherein the resultant vector is equal to a velocity vector of the receiver node 104 minus the velocity vector of the transmitter node 102. In some embodiments, a net frequency shift for a Doppler correction by the receiver node 104 is zero when a vector pointing to the receiver node from the transmitter node 102 is parallel to the Doppler null direction.

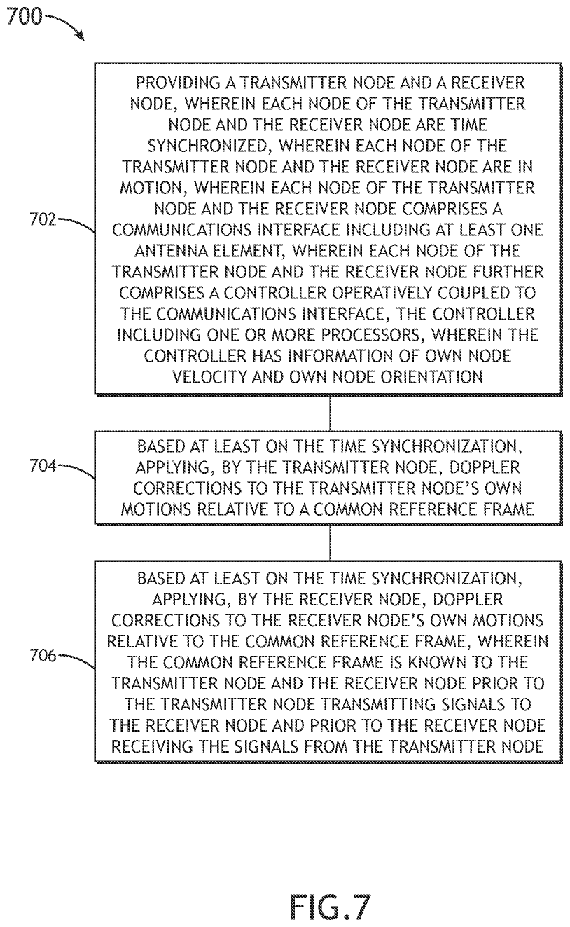

Referring now to FIG. 7, an exemplary embodiment of a method 700 according to the inventive concepts disclosed herein may include one or more of the following steps. Additionally, for example, some embodiments may include performing one or more instances of the method 700 iteratively, concurrently, and/or sequentially. Additionally, for example, at least some of the steps of the method 700 may be performed in parallel and/or concurrently. Additionally, in some embodiments, at least some of the steps of the method 700 may be performed non-sequentially.

A step 702 may include providing a transmitter node and a receiver node, wherein each node of the transmitter node and the receiver node are time synchronized, wherein each node of the transmitter node and the receiver node are in motion, wherein each node of the transmitter node and the receiver node comprises a communications interface including at least one antenna element, wherein each node of the transmitter node and the receiver node further comprises a controller operatively coupled to the communications interface, the controller including one or more processors, wherein the controller has information of own node velocity and own node orientation.

A step 704 may include based at least on the time synchronization, applying, by the transmitter node, Doppler corrections to the transmitter node's own motions relative to a common reference frame.

A step 706 may include based at least on the time synchronization, applying, by the receiver node, Doppler corrections to the receiver node's own motions relative to the common reference frame, wherein the common reference frame is known to the transmitter node and the receiver node prior to the transmitter node transmitting signals to the receiver node and prior to the receiver node receiving the signals from the transmitter node.

Further, the method 700 may include any of the operations disclosed throughout.

The null scanning technique discussed herein illustrates a system and a method for spatial awareness from resolving the temporal spatial characteristics of the transmitter node's 102 radiation. This approach informs the receiver node 104 of the relative speed between the transmitter node 102 and receiver node 104 as well as the transmitter node direction and transmitter node velocity vector. This approach includes scanning through all directions and has a high sensitivity (e.g., low net frequency shift) when the null direction is aligned with the transmitter node direction. This approach can be implemented on a highly sensitive acquisition frame which is typically much more sensitive than explicit data transfers which allow for the ultra-sensitive spatial awareness with relatively low power.

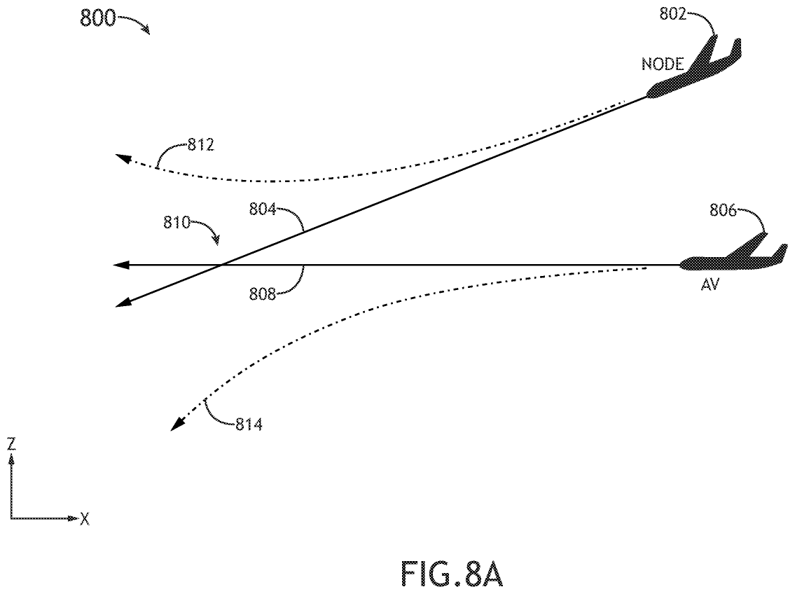

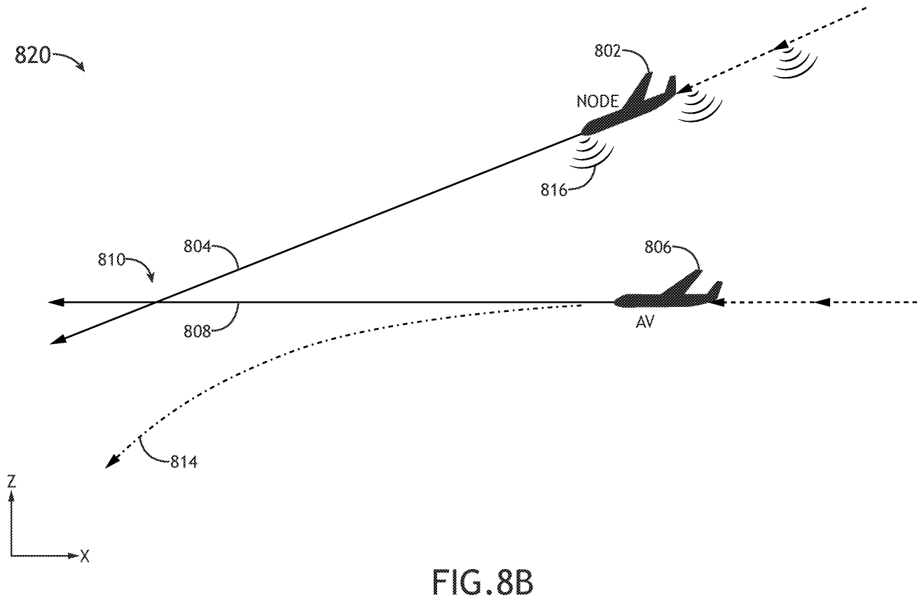

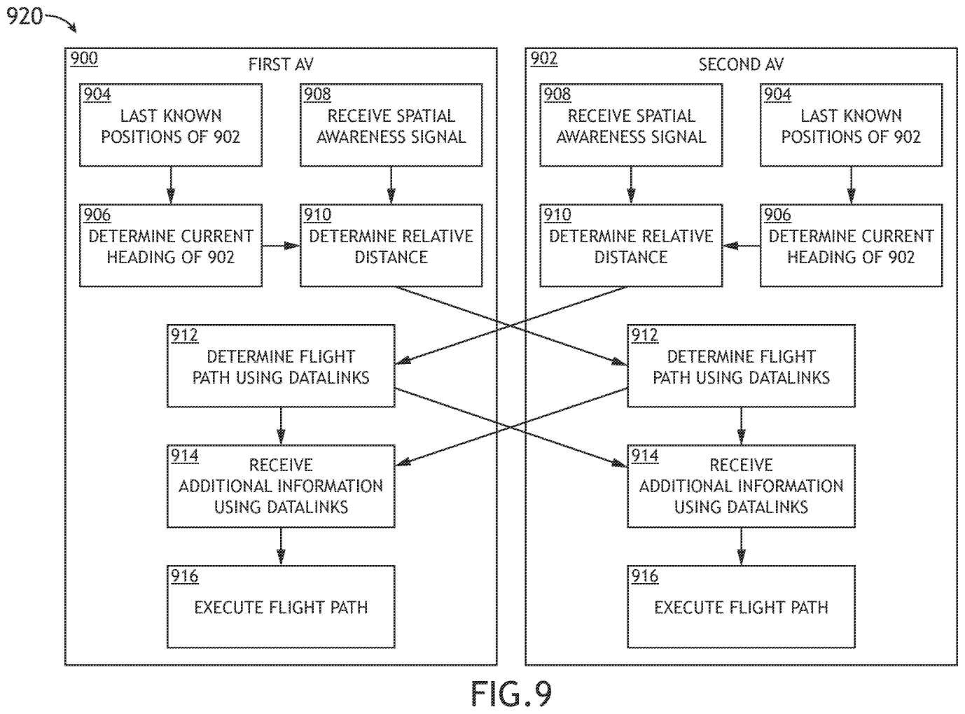

Referring now to FIGS. 8A-9, situational awareness for use in AVs (e.g., UAVs) may be achieved in accordance with one or more embodiments of the present disclosure.

In embodiments, at least a receiver node is configured to be used on an autonomous vehicle (AV). For example, the receiver node may include an antenna, controller, processor, and memory configured for use on an AV. For instance, a UAV such as a drone may include the receiver node. Moreover, for example, instructions stored on memory and configured to be executed by the processor may include autonomous vehicle navigation modules, such as application/software configured to determine flight paths of the AV.

A challenge of loss of a signal of location information (e.g., jamming or interference causing loss of GPS signal) is that nodes may lose track of nearby nodes, increasing the chance of a collision. Further, a challenge of transmitting attributes (e.g., location, speed, bearing, and the like) using typical transmission techniques (e.g., non-doppler nulling methods) is that such techniques may require two-way links, which may be unavailable (e.g., due to SNR requirements) and/or slower to establish a link compared to doppler nulling methods of the present disclosure.

It is contemplated herein that a backup method or system for determining location (e.g., relative and/or absolute location) may address these issues and allow for avoiding collisions.

For purposes of the present disclosure, a node includes an AV (e.g., a UAV), and/or any other entities capable of transmission and/or reception of a signal (e.g., manned vehicles with antennas).

FIG. 8A shows a diagrammatic illustration 800 of an AV 806 and a node 802 with collision avoidance using location information. Some other methods for avoiding collisions transmit information (e.g., data packets with encoded messages) between nodes. Examples of such information includes location information such as GPS coordinates (e.g., latitude: 40.000000, longitude: −60.000000).

As described previously herein, a transmitter node 102 (e.g., node 802) and the receiver node 104 (e.g., AV 806) may be time synchronized to apply Doppler corrections associated with said node's own motions relative to a common reference frame (e.g., a common inertial reference frame (e.g., a common inertial reference frame in motion or a stationary common inertial reference frame)). For example, the common reference frame may be coordinates and may include an altitude. For instance, the common reference frame may be a latitude, longitude, and altitude (e.g., GPS coordinates with altitude). By way of another example, the common reference frame may be understood by way of a relative bearing and relative distance from a common reference point. For instance, the common reference point may be any location, static and/or mobile. In this regard, for example, the common reference point could be another vehicle/node that is moving, a static landmark, or the like. For example, GPS itself, in a general sense, is somewhat like a relative bearing (i.e., longitude) and a relative distance (e.g., latitude) from the North Pole of Earth. Note that GPS is merely used as an example, and a common reference frame is not limited to such an example. For example, the common reference frame may be larger (e.g., based on a coordinate system relative to the Sun of the solar system) or more localized (e.g., based on a coordinate system relative to some point such as the center of a vehicle, ground station, beacon, virtual point not necessarily tied to a tangible object, or the like). In embodiments, using methods herein that use a common reference frame, a receiver node 104 may determine attributes of a transmitter node 102, such as by projecting the transmitter frequency adjustment (Δƒ_{T}) onto the Null direction to determine the velocity of the transmitter node 102.

In embodiments, regardless of the common reference frame (e.g., regardless of whether the common reference frame is based on latitude/longitude/altitude, bearing/distance, or the like), the common reference frame may provide position data based on (i.e., accounting for) inertial drift (rather than only using GPS). For example, the knowledge of the common reference frame (even if it based on GPS signals) may be aided/maintained by accounting for inertial drift. For instance, if a GPS signal is lost or delayed, the future location of a node (e.g., receive node 104) relative to the common reference frame may be determined/estimated using inertial measurement systems (e.g., including accelerometers, gyrometers, and the like). For example, signals from the inertial measurement systems may indicate that the node has traveled 20.05 meters in the same direction over the last second (e.g., for example zero acceleration from the accelerometer combined with a previous known speed of 20.05 m/s along a previous known bearing direction may indicate that the speed is likely to remain the same and in the same direction). A new, updated location relative to the common reference frame may be calculated based on these values by adding a vector representing the 20.05 meters in the known bearing direction to a last known location relative to the common reference frame. In this regard, knowledge of the common reference frame may be maintained, even after loss of GPS. In such a scenario, in embodiments, position error data may be sent between the nodes, such as may be used to maintain a degree of confidence/risk in positions of the nodes over time. For example, the position error data may be indicative of a confidence and/or percent error margin, over time, in the “Doppler corrections” the nodes calculate based on the common reference frame. For instance, the position error data could be a value (e.g., from 0.00 to 1.00) indicative of a percent error (e.g., 0.10 may mean within plus or minus 10%) of the node's own motions (e.g., speed) relative to the common reference frame.

Referring now to AV 806 (or alternatively, first AV 900), the AV 806 may comprise aerial, land, or sea vehicles. For example, the AV 806 may comprise one or more unmanned aerial vehicles (UAVs) or drones. The AV 806 may perform one or more mission tasks/objectives. Tasks include, but are not limited to, search and rescue, pipeline surveillance, reconnaissance, mapping, and extending networked communications. For example, the AV 806 may travel to a location of an objective via default navigation trajectories, and perform additional mission tasks at the shared objective.

In some embodiments, an AV 806 is a vehicle that is fully autonomous (e.g., UAV) such that a user of the AV 806 is remote from the AV 806; but, in some embodiments, the user may be still capable of providing some remote feedback/control. In other embodiments, the AV 806 is a vehicle with autonomous capabilities (e.g., performs one or more tasks via a primary module mainly autonomously) but the vehicle may be capable of simultaneously having a user (e.g., human pilot, overseer) in the vehicle during operation such that the user may provide input (e.g., drive/fly the vehicle, decide tasks, and/or takeover) if desired.

In embodiments, AV 806 may be heading along a planned flight path 808 and node 802 may be heading along a second planned flight path 804. Such flight paths may result in a collision 810 without a change.

Other methods may use a two-way communication link (not shown) to transmit location information (e.g., geographic position information based on GPS signal) as bits in a data packet in order for the AV 806 and node 802 to learn of trajectories and possible collisions 810. Upon a successful transmission of such location information, the AV 806 may avoid collision 810 by changing flight path 808 to an updated flight path 814. Similarly, upon a successful transmission of such location information, the node 802 may avoid collision 810 by changing flight path 804 to an updated flight path 812. In this regard, with a steady supply of location information transmitted between the AV 806 and node 802, each may avoid collision 810. However, location information such as a GPS signal may not always be available, causing at least some other methods to be at risk of potential collisions due to lack of awareness of positions of other nodes 802.

FIG. 8B shows a diagrammatic illustration 820 of an AV 806 and node 806 with collision avoidance using spatial awareness according to example embodiments of this disclosure.

For purposes of the present disclosure, the AV 806 is generally any node, such as a receiver node and the node 802 is generally any node, such as a transmitter node. However, such a description is nonlimiting, and a node may generally both transmit and receive.

In embodiments, the AV 806 (e.g., receiver node) is configured to identify a risk of a potential collision 810 between the AV 806 and the node 802 (e.g., transmitter node) based on signals 816 (e.g., doppler nulling signals having Doppler corrections applied according to the node's 802 own motions relative to a common reference frame).

As shown, in embodiments, the AV 806 and the node 802 may become closer and closer over time. This may result in the signal 816 response being shorter and shorter over time. For example, per a spatial awareness (e.g., doppler nulling) communication protocol known to both nodes (i.e., the AV 806 and node 802), a time synchronized signal may be configured to be sent by the transmitting node at a particular point in time. As the nodes get closer, the delay from when the signal was supposed to be sent and when it is received by AV 806 gets shorter in time. Using the difference in time, the AV 806 may determine/calculate a relative distance between the AV 806 and the node 802. For example, the speed (e.g., 299,792,458 m/s) of a signal 816 in the air may be known. Further, the distance between the nodes 802, 806 may be based on the equation d=c*t, where d is the (relative) distance between nodes, c is the speed of the signal in present medium, and t is the time (e.g., time from when the signal was sent to received). In this regard, the AV 806 may calculate the relative distance between the nodes. In embodiments, the distance between nodes (d) may be in a vector format such as 2D, 3D, and the like. For example, distance between nodes (d) may be 3D coordinates (e.g., vector including an x-direction vector (x), y-direction vector (y), and z-direction vector (z)). In this regard, d=(x²+y²+z²)^{0.5}. Further, the equation d=c*t, may be a function of time in 4 dimensions (e.g., 3D coordinates and time as the fourth dimension), such as F(d)=G(c,t).

In embodiments, the relative distance between nodes may be used to calculate a risk of collision 810. For example, if the relative distance decreases over time, the AV 806 may be configured to adjust the flight path 808 to be updated flight path 814. For example, AV 806 may change a straight heading to an altitude descending heading to reduce the risk of collision 810.

FIG. 9 shows a flow diagram of a method 920 for executing flight plans after loss of a location signal (e.g., GPS signal) according to example embodiments of this disclosure.

For purposes of the present disclosure, referring back to FIG. 8B, the first AV 900 may be any node such as node 802, a transmitter node, and/or a receiver node. Further, the second AV 906 may be any node such as AV 806, a transmitter node, and/or a receiver node.

In embodiments, first node 900 (e.g., a transmitter node and/or receiver node) is configured to initiate the transmitting of signals 816 based on a lack of a default transmitter position information source. For example, a default transmitter position information source may be a satellite (e.g., GPS satellite configured to transmit a signal used to determine absolute position), a two-way communication link node (e.g., an aircraft carrier, ground station, or the like configured for two-way communications of first node 900 position information), or any other signal that includes data for first node 900 positioning purposes.

Note that similar or identical steps may be performed on both the first AV 900 and the second AV 902, such as when both lose a GPS signal and, as a backup or redundancy, use doppler nulling techniques to determine the relative distance and/or positions of each other to avoid collisions.

At a step 904, last known positions of nodes are stored on memory. For example, the last known and transmitted GPS coordinates of second AV 902 may be stored on memory of first AV 900, and vice versa.

At a step 906, the last known positions are used to determine the current heading. For example, a set of last known positions (e.g., position in 2D, 3D (2D coordinates plus time or 3D coordinates), 4D (e.g., 3D coordinates plus time)), and/or the like) occurring along a particular trajectory (e.g., vector in 2D, 3D, 4D, or the like) may be used to identify such a trajectory as the current heading. For example, the first AV 900 may determine the current heading of the second AV 902 based on the last known positions of the second AV 902, and vice versa.

At a step 908, a spatial awareness signal (e.g., signal 816 using any embodiment herein, such as those incorporated by reference) may be received by a node from another node. For example, the second AV 902 may be configured to transmit a signal 816 and the first AV 900 may be configured to receive such a signal 816, and vice versa. In embodiments, such a signal may be configured to be sent for a variety of reasons, including, but not limited to, by default during all times of operation, or as a result of a determination of a lack of other positioning information.

At a step 910, a relative distance may be determined. For example, the relative distance between AVs 900, 902 may be determined as described above, such as by using the speed of transmission and the time the signal takes to travel between the AVs 900, 902.

At a step 912, a flight path (e.g., an adjustment to the first AV's 900 own flight path) may be determined. For example, the relative distances may reduce over time and such a reduction may be used to determine that the heading of the second AV 902 has changed and the second AV 902 is getting closer to the first AV 900. Such a determination may be used to identify a risk of collision. Further, such a determination may be used, by the first AV 900, to determine an adjustment to the flight path of the first AV 900. For example, as shown in FIG. 8B, a reduction in relative distances over time may be used to determine that the flight path 808 should be adjusted to a descending flight path 814.

For example, the first AV 902 may determine the flight path of the second AV 902 based on the relative distances determined in step 910. Moreover, the current heading of the second AV 902 may have been parallel (not shown) to the first AV 900, but it may have changed after the loss of GPS signal. For instance, the changed flight path may be represented by flight path 804 of FIG. 8B, putting the AVs, 900, 902 at risk of collision 810. In embodiments, a decreasing of the relative distance over time may be indicative of a change in flight path towards the first AV 900. In this regard, the signals 816 resulting in calculation of relative distances may allow for sensing a change in flight paths of other nodes, and be used to adjust a flight path of the node receiving the signals 816.

In embodiments, step 912 may be performed, but is not required to, using data from datalinks (i.e., crossing lines in FIG. 9). For example, a datalink may be a two-way communication for transmitting information and step 912 may be based off of that information. For example one or more of the nodes may send the relative distance information to one or more other nodes. Although both of the AVs 900, 902 are shown as determining relative distances, in some embodiments, only the second AV 900 necessarily does so. For example, the first AV 900 may transmit a signal to the second AV 902 and the second AV 902 may send a calculated relative distance back to the first AV via a different communication protocol (e.g., two-way communication protocol).

At a step 914, additional information is received via a datalink (e.g., the same datalink). For example, one or more of the nodes 900, 902 may transmit their current flight plan (e.g., an adjusted flight plan configured to avoid a collision 810). For instance, such a transmission may be used by each node 900, 902 to check that the most up to date flight plans are acceptable (e.g., safe). For example, if both nodes 900, 902 had both determined to adjust their flight plan to turn left to avoid a collision 810 (rather than one descend and one ascend), then the risk of collision would not necessarily be reduced and their flight plans would not necessarily be acceptable. In such a scenario, the nodes 900, 902 may be configured to select a set of adjusted flight plans to minimize a risk of collision. For example, the set of adjusted flight plans may be that one node ascends and one node descends, that one node turns left and one node turns right (along the Y axis of FIG. 8B), and the like, such that each node stays a minimum threshold distance (e.g., any distance such as at least 5 m, at least 10 m, at least 50 m, at least 200 m, at least 1000 m, and the like) from other nodes.

At a step 916, a flight path is executed (e.g., directed by controller to be performed by autonomous driving/flying software of the vehicle using actuators, etc.). For example, the flight path may be an adjusted flight path configured to reduce the risk of the collision 810.

At least some embodiments of the present disclosure allow for reducing the risk of collision during a lack of other position information.

### CONCLUSION

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

We claim:

1. A system, comprising:
a transmitter node and a receiver node, wherein each node of the transmitter node and the receiver node comprises:
a communications interface including at least one antenna element; and
a controller operatively coupled to the communications interface, the controller including one or more processors, wherein the controller has information of own node velocity and own node orientation;
wherein each node of the transmitter node and the receiver node are in motion relative to each other,
wherein each node of the transmitter node and the receiver node are time synchronized to apply Doppler corrections associated with said node's own motions relative to a common reference frame,
wherein the common reference frame is known to the transmitter node and the receiver node prior to the transmitter node transmitting signals to the receiver node and prior to the receiver node receiving the signals from the transmitter node,
wherein at least the receiver node is configured to be used on an autonomous vehicle, wherein the receiver node is configured to identify a risk of a potential collision between the receiver node and the transmitter node based on the signals.

2. The system of claim 1, wherein the receiver node is configured to adjust a flight path based on the signals to reduce the risk of the potential collision.

3. The system of claim 1, wherein the transmitter node is configured to initiate the transmitting of the signals based on a lack of a default transmitter position information source.

4. The system of claim 1, wherein the common reference frame is a common inertial reference frame.

5. The system of claim 1, wherein the receiver node is configured to adjust a receiver frequency of the receiver node according to an own speed and an own velocity direction of the receiver node so as to perform a receiver-side Doppler correction.

6. The system of claim 5, wherein an amount of adjustment of the adjusted transmit frequency is proportional to a transmitter node velocity projection onto a Doppler null direction, wherein an amount of adjustment of the adjusted receiver frequency is proportional to a receiver node velocity projection onto the Doppler null direction.

7. The system of claim 6, wherein the receiver node is configured to determine a relative speed between the transmitter node and the receiver node.

8. The system of claim 7, wherein the receiver node is configured to determine a direction that the transmitter node is in motion and a velocity vector of the transmitter node.

9. The system of claim 8, wherein a maximum net frequency shift for a Doppler correction by the receiver node occurs when a resultant vector is parallel to the Doppler null direction, wherein the resultant vector is equal to a velocity vector of the receiver node minus the velocity vector of the transmitter node.

10. The system of claim 8, wherein a minimum net frequency shift for a Doppler correction by the receiver node occurs when a resultant vector is antiparallel to the Doppler null direction, wherein the resultant vector is equal to a velocity vector of the receiver node minus the velocity vector of the transmitter node.

11. The system of claim 8, wherein a net frequency shift for a Doppler correction by the receiver node is zero when a vector pointing to the receiver node from the transmitter node is parallel to the Doppler null direction.

12. The system of claim 1, wherein the transmitter node and the receiver node are time synchronized via synchronization bits associated with acquisition.

13. The system of claim 12, wherein the synchronization bits operate as physical layer overhead.

14. The system of claim 1, wherein each node of the transmitter node and the receiver node are in motion in three dimensions.

15. The system of claim 1, wherein each node of the transmitter node and the receiver node are in motion in two dimensions.

16. The system of claim 1, wherein the system is a mobile ad-hoc network (MANET) comprising the transmitter node and the receiver node.

17. A method, comprising:
providing a transmitter node and a receiver node, wherein each node of the transmitter node and the receiver node are time synchronized, wherein each node of the transmitter node and the receiver node are in motion relative to each other, wherein each node of the transmitter node and the receiver node comprises a communications interface including at least one antenna element, wherein each node of the transmitter node and the receiver node further comprises a controller operatively coupled to the communications interface, the controller including one or more processors, wherein the controller has information of own node velocity and own node orientation;
based at least on the time synchronization, applying, by the transmitter node, Doppler corrections to the transmitter node's own motions relative to a common reference frame; and
based at least on the time synchronization, applying, by the receiver node, Doppler corrections to the receiver node's own motions relative to the common reference frame;
wherein the common reference frame is known to the transmitter node and the receiver node prior to the transmitter node transmitting signals to the receiver node and prior to the receiver node receiving the signals from the transmitter node,
wherein at least the receiver node is configured to be used on an autonomous vehicle,
wherein the receiver node is configured to identify a risk of a potential collision between the receiver node and the transmitter node based on the signals.

18. The system of claim 1, wherein the receiver node is configured to adjust a flight path based on the signals to reduce the risk of the potential collision.

19. The system of claim 1, wherein the transmitter node is configured to initiate the transmitting of the signals based on a lack of a default transmitter position information source.

20. The method of claim 17, further comprising:
adjusting, by the receiver node, a receiver frequency of the receiver node according to an own speed and an own velocity direction of the receiver node so as to perform a receiver-side Doppler correction;
determining, by the receiver node, a relative speed between the transmitter node and the receiver node; and
determining, by the receiver node, a direction that the transmitter node is in motion and a velocity vector of the transmitter node,
wherein an amount of adjustment of the adjusted transmit frequency is proportional to a transmitter node velocity projection onto a Doppler null direction, wherein an amount of adjustment of the adjusted receiver frequency is proportional to a receiver node velocity projection onto the Doppler null direction.
